(19) United States
(12) Patent Application Publication
(10) Pub. No.: US 2015/0300866 A1
(43) Pub. Date: Oct. 22, 2015

(54) RADAR LEVEL GAUGE

(71) Applicants: VLADIMIR VINIAMINOVICH LIBERMAN, TULA (RU); GENNADY GENNADYEVICH LICHKOV, TULA (RU); SERGEI ALEKSANDROVICH NOVIKOV, TULA (RU)

(72) Inventors: VLADIMIR VINIAMINOVICH LIBERMAN, TULA (RU); GENNADY GENNADYEVICH LICHKOV, TULA (RU); SERGEI ALEKSANDROVICH NOVIKOV, TULA (RU)

(21) Appl. No.: 14/639,298

(22) Filed: Mar. 5, 2015

(30) Foreign Application Priority Data
Apr. 22, 2014 (RU) 2014116221

(51) Int. Cl. G01F 23/284; G01P 15/00; G01S 13/88; H01Q 1/22

(52) U.S. Cl. CPC G01F 23/284; H01Q 1/225; G01P 15/00; G01S 13/88

(57) ABSTRACT

Control and measuring of liquid and free-flowing substances levels in reservoirs is described. A radar level gauge is equipped with a level sensor, a detection pattern control unit of the microstrip antenna, an interface converter and a control device. A control unit of the detection pattern control unit is installed on its internal side and contains controllable phase shifting devices and an angular position measurement unit. The position of the microstrip antenna detection pattern is changed via phase control of a sounding signal produced by groups of elementary radiators. The phase shifting devices are controlled through a control device. A control signal is generated based on data provided by a measurement unit on the current angular position of the plane of the microstrip antenna and on the required inclination angle of the detection pattern sent by the level sensor.

### CROSS-REFERENCE TO RELATED APPLICATION

The instant application claims priority to Russian Patent Application Serial No. 2014116221, filed Apr. 22, 2014, the entire specification of which is expressly incorporated herein by reference.

### FIELD OF THE INVENTION

The invention concerns control and measuring of liquid and free-flowing substances level in reservoirs and can be used at chemical, oil-producing, oil-processing and other facilities using the reservoirs filled with liquid and free-flowing substances.

### BACKGROUND OF THE INVENTION

It is known that there is a non-contact radar level gauge containing a level sensor using a parabolic antenna together with a positioning device based on a ball seat (e.g., see U.S. Pat. No. 7,561,113).

The sensor with a parabolic antenna and the positioning device are located on the top of a reservoir. The non-contact radar level gauge is installed by bolting of the ball seat flange to the counter flange of the reservoir nipple. It assures a rigid connection between the positioning device flange and the reservoir nipple flange. The antenna position inside the reservoir is changed by rotation of the ball seat with further fixation of its position with the help of a fixing flange.

This mechanical way of the antenna orientation change in the space demonstrates some disadvantages at level measuring of both liquid and free-flowing products. Because it is not possible to remotely control the position of the antenna detection pattern in the space under investigation it has a negative impact on radar level gauge performance in general. For liquid products level measurement the antenna detection pattern and the measured surface must be mutually perpendicular. In this case the accuracy of the antenna orientation should increase with decreasing of the antenna detection pattern width. In case of rather small values of the detection pattern width the level of a useful signal can significantly drop due to the reasons related to the reservoir top temperature deformation, for instance. It can require the antenna repositioning. Level measuring of free-flowing substances has its unique features. This is due to the fact that the surface of such substances is not smooth and sometimes can have irregular structure; in this case, there is no mirror-reflection of the antenna sounding signal that sometimes results in its partial or complete loss. In such a case the change of the antenna position can contribute to a useful signal occurrence. It is also worth noting that the mechanical way of the level gauge antenna orientation can be rather problematic in case of installation in open field conditions in the event of unfavorable weather conditions, for instance.

### SUMMARY OF THE INVENTION

The authors faced the task to create a radar level gauge reliably operating in case of level change of liquid and free-flowing products in reservoirs and tanks of different types and not requiring from maintenance personnel any activities related correction of the antenna position during the device operation.

The problem is solved in the following way: the radar level gauge equipped with a level sensor using a microstrip antenna, an interface converter and a control device was additionally fitted with a microstrip antenna detection pattern control unit, the signal input of this control unit is connected with the level sensor and the signal output is connected with the microstrip antenna. Besides, the control input and the data output of the detection pattern control unit are connected with the control device.

The detection pattern control unit is equipped with phase shifting devices and with an angular position measurement unit of the microstrip antenna.

The phase shifting devices are located inside the microstrip antenna.

The phase shifting devices are made based on the microcircuits using a varactor for signal phase control.

The angular position measurement unit of the microstrip antenna is located inside it.

The angular position measurement unit of the microstrip antenna is made based on a solid- state accelerometer.

Inclusion of the microstrip antenna detection pattern control unit allows quickly (without mechanical operations) change the beam position inside the volume of interest in accordance with a preset algorithm that will result in achievement of a technical result in the form of the level gauge performance improvement through increase of level measurement accuracy of liquid and free-flow products in reservoirs.

The claimed radar level gauge has a set of significant features not known in the prior art for the products of similar designation, that allows making a conclusion on the correspondence to the “novelty” criterion.

According to the claimer and authors the claimed radar level gauge meets the criteria of the “inventive level,” because for specialists it does not follow from the prior art, i.e., that by the date of the filing of the application it is not included in available sources of scientific, technical and patent information.

In accordance with the general teachings of the present invention, systems and methods for control and measuring of liquid and free-flowing substances levels in reservoirs are provided and can be used at chemical, oil-producing, oil-processing and other facilities using the reservoirs filled with liquid and free-flowing substances. The technical result is improvement of the level gauge performance through an increase of level measurement accuracy of the products in the reservoirs. A radar level gauge is equipped with a level sensor, a detection pattern control unit of the microstrip antenna, an interface converter and a control device. A control unit of microstrip antenna detection pattern control unit is installed on its internal side and contains controllable phase shifting devices and an angular position measurement unit. The position of the microstrip antenna detection pattern is changed via phase control of a sounding signal produced by different groups of elementary radiators. The phase shifting devices are controlled through a control device. A control signal is generated based on the data provided by the measurement unit on the current angular position of the plane of the microstrip antenna and on the required inclination angle of the detection pattern sent by the level sensor. The phase shifting devices are made based on the microcircuits using a varactor for signal phase control. The angular position measurement unit of the microstrip antenna is made based on a solid-state accelerometer.

### BRIEF DESCRIPTION OF THE DRAWINGS

The nature of the claimed radar level gauge is explained in the drawings, where:

FIG. 1 illustrates a flow chart;

FIG. 2 illustrates a view of the microstrip antenna from outside;

FIG. 3 illustrates a view of the microstrip antenna from inside; and

FIG. 4 illustrates a schematic electrical diagram of the antenna angular position measurement unit.

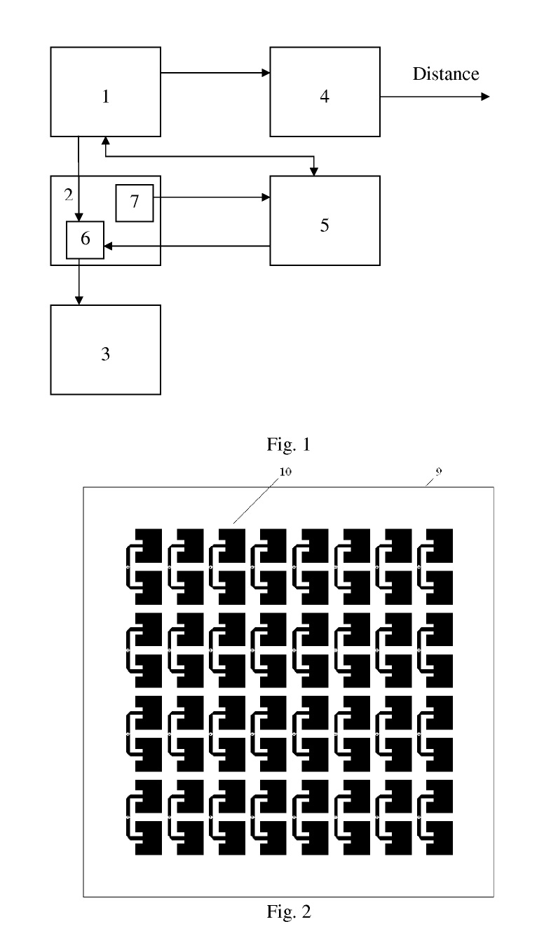

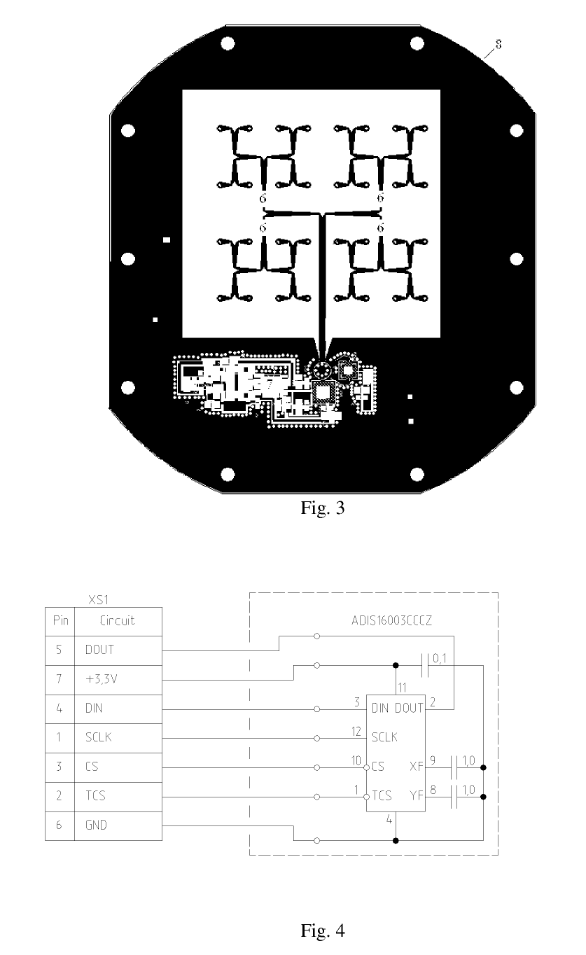

### DETAILED DESCRIPTION OF THE INVENTION

Referring to the Figures, the radar level gauge is equipped with a level sensor (1), a detection pattern control unit (2) of the microstrip antenna (3), an interface converter (4) and a control device (5).

The detection pattern control unit (2) of the microstrip antenna (3) contains four controllable phase shifting devices (6) and an angular position measurement unit (7) of the microstrip antenna (3).

The microstrip antenna (3) consists of two parts, internal (8) and external (9). The internal part (8) of the antenna (3) is a printed-circuit board made of laminated plastic microwave material. This part of the antenna (3) contains a power distribution wiring of the elementary radiators (10) groups and a detection pattern control unit (2) of the microstrip antenna (3). The external part (9) of the antenna (3) is also made as a printed-circuit board made of laminated plastic microwave material and contains elementary radiators (10). Both parts are electrically connected and constitute a full design.

HMC 933LP4E microcircuits produced by Hittite Microwave Corporation are used as controllable phase shifting devices (6). The microcircuit includes varactors and matching circuits.

The angular position measurement unit (7) of the microstrip antenna is made based on a microcircuit of the solid-state accelerometer ADIS 16003 produced by the company Analog Devices. The microcircuit includes two analog acceleration transducers (for both coordinates) and a controller converting the analog signal from these sensors to a digital code containing information on inclination angle.

Radar level gauge operates as follows. Level sensor (1) generates the sounding signal going through the detection pattern control unit (2) and radiated by the microstrip antenna (3) in the direction of the object, the distance to which is to be measured. The signal reflected from the border section environments returns to the level sensor (1). Frequency of the sounding signal varies with time under the sawtooth law. Quite a number of spectral components which frequency bear some data on the distance is produced as a result of interaction of the sounding and reflected signals in the level sensor (1). The data from the level sensor (1) after the corresponding processing is transferred to the interface converter (4) after which the distance value in digitized form is generated for the post-processing.

The position of the microstrip antenna (3) detection pattern is changed via phase control of the sounding signal produced by different groups of elementary radiators (10). The phase shifting devices (6) are controlled through a control device (5). Control signal is generated based on the data provided by the measurement unit (7) on the current angular position of the plane of the microstrip antenna (3) and on the required inclination angle of the detection pattern sent by the level sensor (1).

Original position of the microstrip antenna (3) detection pattern is determined by the plane angle of the reservoir counter-flange. Prior to operation of the radar level gauge the angular correction of the microstrip antenna (3) detection pattern is made to compensate the position of measurement beam that is different from the required one.

This correction allows providing the mutual perpendicularity of the microstrip antenna (3) detection pattern and the check surface.

Control algorithm of the microstrip antenna (3) detection pattern supposes the search of optimal inclination angle of the measurement beam under the criterion of maximum level reflected from the signal surface being studied. Determination of the scan borders is made with regard to the width value of the detection pattern based on the values of current distance, the reservoir geometric parameters and current angle value coming from the angular position measurement unit (7) of the microstrip antenna (3).

Taking this into consideration there is a possibility of on-line angle position correction of the microstrip antenna (3) detection pattern without human input to compensate any change of its angular position occurred due to different causes, for example, the thermal expansions of the reservoir construction elements or in case of the total signal absence when operating with bulk materials.

At the applicant enterprise the design documentation for the radar level gauge of the claimed construction was prepared, its pilot sample was manufactured which tests confirmed its serviceability and benefits in comparison with known ones that allows making a conclusion on the correspondence to the “industrial applicability” criterion for the invention.

What is claimed is:

1. A radar level gauge containing the level sensor with the usage of the microstrip antenna, interface converter and control device, characterized in that it is additionally equipped with the detection pattern control unit of the microstrip antenna which signal input is connected with the level sensor and the signal output is connected with the microstrip antenna, while the control input and data output of the detection pattern control unit are connected with the control device.

2. The radar level gauge of claim 1, wherein the detection pattern control unit of the microstrip antenna is located at its internal side.

3. The radar level gauge of claim 1, wherein the detection pattern control unit is equipped the phase shifting devices and angular position measurement unit of the microstrip antenna.

4. The radar level gauge of claim 3, wherein the phase shifting devices are made based on the microcircuits using varactor for signal phase control.

5. The radar level gauge of claim 3, wherein the angular position measurement unit of the microstrip antenna is made based on a solid-state accelerometer.
